(19) United States
(12) Patent Application Publication
(10) Pub. No.: US 2025/0376604 A1
(43) Pub. Date: Dec. 11, 2025

(54) SILICA-BASED SLURRY FOR SELECTIVE POLISHING OF SILICON NITRIDE AND SILICON CARBIDE

(71) Applicant: ENTEGRIS, INC., Billerica, MA (US)

(72) Inventors: Elena C. Montoto-Blanco, Chicago, IL (US); Brian Reiss, Woodridge, IL (US); Alex Villani-Gale, Chicago, IL (US); Tamil Sakthivel, Aurora, IL (US); Alexander W. Hains, Aurora, IL (US); Elliot Knapton, Aurora, IL (US); Julianne Truffa, New Lenox, IL (US)

(21) Appl. No.: 19/224,143

(22) Filed: May 30, 2025

Related U.S. Application Data
(60) Provisional application No. 63/656,378, filed on Jun. 5, 2024.

(51) Int. Cl. C09G 1/02; B24B 1/00

(52) U.S. Cl. CPC C09G 1/02; B24B 1/00

(57) ABSTRACT

The invention provides a chemical-mechanical polishing composition comprising: (a) a silica abrasive, (b) a buffering agent, and (c) water, wherein the polishing composition has a pH of about 1 to about 7 and the silica abrasive has a zeta potential of about −10 mV to about −50 mV in the polishing composition. The invention also provides a method of chemically-mechanically polishing a substrate, especially a substrate comprising silicon carbide and/or silicon nitride, using said composition.

### BACKGROUND OF THE INVENTION

In the fabrication of integrated circuits and other electronic devices, multiple layers of conducting, semiconducting, and dielectric materials are deposited onto or removed from a substrate surface. As layers of materials are sequentially deposited onto and removed from the substrate, the uppermost surface of the substrate may become non-planar and require planarization. Planarizing a surface, or “polishing” a surface, is a process where material is removed from the surface of the substrate to form a generally even, planar surface. Planarization is useful in removing undesired surface topography and surface defects, such as rough surfaces, agglomerated materials, crystal lattice damage, scratches, and contaminated layers or materials. Planarization also is useful in forming features on a substrate by removing excess deposited material used to fill the features and to provide an even surface for subsequent levels of metallization and processing.

Compositions and methods for planarizing or polishing the surface of a substrate are well known in the art. Chemical-mechanical planarization, or chemical-mechanical polishing (CMP), is a common technique used to planarize substrates. CMP utilizes a chemical composition, known as a CMP composition or more simply as a polishing composition (also referred to as a polishing slurry), for selective removal of material from the substrate. Polishing compositions typically are applied to a substrate by contacting the surface of the substrate with a polishing pad (e.g., polishing cloth or polishing disk) saturated with the polishing composition. The polishing of the substrate typically is further aided by the chemical activity of the polishing composition and/or the mechanical activity of an abrasive suspended in the polishing composition or incorporated into the polishing pad (e.g., fixed abrasive polishing pad).

The next generation of semiconductor devices are increasingly relying on hard materials such as silicon carbide and silicon nitride in their construction. Silicon carbide has high electric field strength, excellent thermal stability, and a wide band gap compared to traditional silicon materials. On the other hand, silicon nitride is a hard material used in, for example, etch stop masks, electrical insulators, and as a dielectric material in capacitors. Thus, the ability to selectively remove silicon carbide and silicon nitride from a substrate without removing desirable dielectric materials such as, for example, silicon oxide, represents a challenge for chemical-mechanical polishing (CMP), particularly in view of silicon carbide and silicon nitride being significantly harder and more chemically inert than other materials comprising integrated circuits.

As the technology for integrated circuit devices advances, traditional materials are being used in new and different ways to achieve the level of performance needed for advanced integrated circuits. In particular, silicon nitride, silicon carbide, and silicon dioxide are being used in various combinations to achieve new and even more complex device configurations. In general, the structural complexity and performance characteristics vary across different applications.

Accordingly, there is an ongoing need to develop new polishing compositions and methods that provide relatively high rates of removal of silicon carbide and silicon nitride and selectively remove silicon carbide and silicon nitride in preference to other materials present on the surface of the semiconductor substrate. The invention provides such polishing compositions and methods. These and other advantages of the invention, as well as additional inventive features, will be apparent from the description of the invention provided herein.

### BRIEF SUMMARY OF THE INVENTION

The invention provides a chemical-mechanical polishing composition comprising:
(a) a silica abrasive,
(b) a buffering agent, and
(c) water,
   wherein the polishing composition has a pH of about 1 to about 7 and the silica abrasive has a zeta potential of about −10 mV to about −50 mV in the polishing composition.

The invention further provides a method of chemically-mechanically polishing a substrate comprising: (i) providing a substrate, (ii) providing a polishing pad, (iii) providing a chemical-mechanical polishing composition comprising: (a) a silica abrasive, (b) a buffering agent, and (c) water, wherein the polishing composition has a pH of about 1 to about 7 and the silica abrasive has a zeta potential of about −10 mV to about −50 mV in the polishing composition, (iv) contacting the substrate with the polishing pad and the chemical-mechanical polishing composition, and (v) moving the polishing pad and the chemical-mechanical polishing composition relative to the substrate to abrade at least a portion of the substrate to polish the substrate.

### BRIEF DESCRIPTION OF THE DRAWINGS

FIG. 1 is a graph showing the mean removal rate (Å/min) of plasma enhanced (PE) chemical vapor deposited silicon nitride (SiN) and tetraethyl orthosilicate as a function of polishing condition, as described in Example 1.

FIG. 2 is a graph showing the mean removal rate (Å/min) of plasma enhanced (PE) chemical vapor deposited silicon nitride (SiN) and tetraethyl orthosilicate as a function of silicate-based silica abrasive, as described in Example 2.

FIG. 3 is a graph showing the mean removal rate (Å/min) of plasma enhanced (PE) chemical vapor deposited silicon nitride (SiN), low pressure (LP) chemical vapor deposited silicon nitride (SiN), and tetraethyl orthosilicate as a function of silicate-based silica abrasive, as described in Example 3.

### DETAILED DESCRIPTION OF THE INVENTION

The invention provides a chemical-mechanical polishing composition comprising: (a) a silica abrasive, (b) a buffering agent, and (c) water, wherein the polishing composition has a pH of about 1 to about 7 and the silica abrasive has a zeta potential of about −10 mV to about −50 mV in the polishing composition.

The polishing composition comprises a silica abrasive. As used herein, the terms “silica abrasive,” “silica abrasive particle,” “silica particle,” and “abrasive particle” can be used interchangeably, and can refer to any silica particle (e.g., silicate-based silica abrasive). The silica particle (e.g., silicate-based silica abrasive) can be modified (e.g., surface modified) or unmodified, and has a negative native zeta potential, a positive native zeta potential, or an approximately neutral native zeta potential. As used herein, the phrase “native zeta potential” refers to the zeta potential of the silica abrasive prior to adding the silica abrasive to the polishing composition. For example, the native zeta potential can refer to the zeta potential of a silica abrasive prior to adding the silica abrasive to the polishing composition as measured in a storage dispersion or an aqueous dispersion. A skilled artisan will be able to determine whether the silica abrasive, prior to adding the silica abrasive to the polishing composition, has a negative native zeta potential or a positive native zeta potential. The charge on dispersed particles such as a silica abrasive (e.g., silicate-based silica abrasive) is commonly referred to as the zeta potential (or the electrokinetic potential). The zeta potential of a particle refers to the electrical potential difference between the electrical charge of the ions surrounding the particle and the electrical charge of the bulk solution of the composition in which it is measured (e.g., the liquid carrier and any other components dissolved therein). The zeta potential is typically dependent on the pH of the aqueous medium. For a given polishing composition, the isoelectric point of the particles is defined as the pH at which the zeta potential is zero. As the pH is increased or decreased away from the isoelectric point, the surface charge (and hence the zeta potential) is correspondingly decreased or increased (to negative or positive zeta potential values). The native zeta potential and the zeta potential of the polishing composition may be obtained using the Model DT-1202 Acoustic and Electro-acoustic spectrometer available from Dispersion Technologies, Inc. (Bedford Hills, N.Y.) or with electrophoretic light scattering using a Malvern Zetasizer available from Malvern Panalytical (Malvern, United Kingdom). As used herein, the phrase “negative zeta potential” refers to a silica abrasive that exhibits a negative surface charge when measured in the polishing composition.

The silica abrasive has a zeta potential of about −10 mV to about −50 mV in the polishing composition. For example, the silica abrasive can have a zeta potential of from about −10 mV to about −45 mV, e.g., from about −10 mV to about −40 mV, from about −10 mV to about −35 mV, from about −10 mV to about −30 mV, from about −10 mV to about −25 mV, from about −15 mV to about −50 mV, from about −15 mV to about −45 mV, from about −15 mV to about −40 mV, from about −15 mV to about −35 mV, from about −15 mV to about −30 mV, from about −15 mV to about −25 mV, from about −20 mV to about −50 mV, from about −20 mV to about −45 mV, from about −20 mV to about −40 mV, from about −20 mV to about −35 mV, from about −20 mV to about −30 mV, from about −20 mV to about −25 mV, from about −25 mV to about −50 mV, from about −25 mV to about −45 mV, from about −25 mV to about −40 mV, from about −25 mV to about −35 mV, or from about −25 mV to about −30 mV. In some embodiments, the silica abrasive has a zeta potential of about −15 mV to about −35 mV in the polishing composition. In certain embodiments, the silica abrasive has a zeta potential of about −20 mV to about −30 mV in the polishing composition.

Silica particles (e.g., silicate-based silica abrasive) can be prepared by various methods, some examples of which are commercially used and known. Useful silica particles include precipitated or condensation-polymerized silica, which may be prepared using known methods, such as by methods referred to as the “sol gel” method or by silicate ion-exchange. Condensation-polymerized silica particles are often prepared by condensing Si(OH) 4 to form substantially spherical (e.g., spherical, ovular, or oblong) particles. The precursor Si(OH) 4 may be obtained, for example, by hydrolysis of high purity alkoxysilanes, or by acidification of aqueous silicate solutions. U.S. Pat. No. 5,230,833 describes a method for preparing colloidal silica particles in solution. In some embodiments, the silica abrasive is a silicate-based silica abrasive, e.g., the silica abrasive is not formed using a Stöber process (Stober et al., Journal of Colloid and Interface Science, 26 (1): 62−69 (1968)). In certain embodiments, the silica abrasive is a surface modified (e.g., an organic silane coated) silicate-based silica abrasive. Badley et al. (Langmuir, 6, 792−801 (1990)) describes an exemplary method for modifying the surface of silica (e.g., colloidal silica). In some embodiments, the silicate-based silica abrasive is not an orthosilicate-based particle such as tetramethyl orthosilicate. In other words, in some embodiments, the silica abrasive is not formed using a Stöber process (Stober et al., Journal of Colloid and Interface Science, 26 (1): 62−69 (1968)).

Typically, orthosilicate-based particles such as tetramethyl orthosilicate have a density of 1.8-2.1 g/mL, as determined by an ethyl alcohol pycnometer. In contrast, silicate-based silica abrasive particles, e.g., silica abrasive particles that are not formed using a Stöber process, have a density that is slightly higher than the density of orthosilicate-based particles such as tetramethyl orthosilicate. Thus, in some embodiments, the silica abrasive has a density of 2.2-2.8 g/mL, 2.2-2.7 g/mL, 2.2-2.6 g/mL, 2.2-2.5 g/mL, 2.2-2.4 g/mL, or 2.2-2.3 g/mL, as determined by an ethyl alcohol pycnometer.

In some embodiments, the silica abrasive is colloidal silica. As is known to one of ordinary skill in the art, colloidal silicas are suspensions of fine amorphous, nonporous and typically spherical particles in a liquid phase. The colloidal silica can take the form of condensation-polymerized or precipitated silica particles. In some embodiments, the silica is in the form of wet-process type silica particles. The particles, e.g., colloidal silica, can have any suitable average size (i.e., average particle diameter). If the average abrasive particle size is too small, the polishing composition may not exhibit sufficient removal rate. In contrast, if the average abrasive particle size is too large, the polishing composition may exhibit undesirable polishing performance such as, for example, poor substrate defectivity.

Accordingly, the silica abrasive (e.g., silicate-based silica particles) can have an average particle size of about 10 nm or more, for example, about 15 nm or more, about 20 nm or more, about 25 nm or more, about 30 nm or more, about 35 nm or more, about 40 nm or more, about 45 nm or more, or about 50 nm or more. Alternatively, or in addition, the silica abrasive can have an average particle size of about 200 nm or less, for example, about 175 nm or less, about 150 nm or less, about 125 nm or less, about 100 nm or less, about 75 nm or less, about 50 nm or less, or about 40 nm or less. Thus, the silica abrasive can have an average particle size bounded by any two of the aforementioned endpoints.

For example, the silica abrasive (e.g., silicate-based silica particles) can have an average particle size of about 10 nm to about 200 nm, e.g., about 20 nm to about 200 nm, about 20 nm to about 175 nm, about 20 nm to about 150 nm, about 25 nm to about 125 nm, about 25 nm to about 100 nm, about 30 nm to about 100 nm, about 30 nm to about 75 nm, about 30 nm to about 50 nm, about 30 nm to about 40 nm, or about 50 nm to about 100 nm. For non-spherical silica abrasive particles, the size of the particle is the diameter of the smallest sphere that encompasses the particle. The particle size of the abrasive can be measured using any suitable technique, for example, using laser diffraction techniques. Suitable particle size measurement instruments are available from e.g., Malvern Instruments (Malvern, UK). In some embodiments, the silica abrasive has an average particle size of about 20 nm to about 150 nm. In certain embodiments, the silica abrasive has an average particle size of about 30 nm to about 50 nm.

The silica abrasive (e.g., silicate-based silica abrasive) preferably is colloidally stable in the polishing composition. The term colloid refers to the suspension of particles in the liquid carrier (e.g., water). Colloidal stability refers to the maintenance of that suspension through time. In the context of this invention, an abrasive is considered colloidally stable if, when the abrasive is placed into a 100 mL graduated cylinder and allowed to stand unagitated for a time of 2 hours, the difference between the concentration of particles in the bottom 50 mL of the graduated cylinder ([B] in terms of g/mL) and the concentration of particles in the top 50 mL of the graduated cylinder ([T] in terms of g/mL) divided by the initial concentration of particles in the abrasive composition ([C] in terms of g/mL) is less than or equal to 0.5 (i.e., {[B]−[T]}/[C]≤0.5). More preferably, the value of [B]−[T]/[C] is less than or equal to 0.3, and most preferably is less than or equal to 0.1.

In some embodiments, the silica abrasive is not doped with aluminum. In other words, in some embodiments, the silica abrasive does not contain aluminum. In certain embodiments, the silica abrasive is not doped with a metal. In other words, in certain embodiments, the silica abrasive does not contain a metal or metalloid other than silicon. For example, in certain embodiments, the silica abrasive comprises silicon and other non-metallic elements such as, for example, oxygen, carbon, nitrogen, sulfur, and phosphorus. Without wishing to be bound by any particular theory, it is believed that for certain applications it may be desirable to utilize a silica abrasive that does not contain a metal or metalloid other than silicon to improve polishing performance (e.g., by reducing particle defects to the surface of a substrate).

The silica abrasive can be present in the polishing composition in any suitable amount. If the polishing composition of the invention comprises too little abrasive, the composition may not exhibit sufficient removal rate. In contrast, if the polishing composition comprises too much abrasive then the polishing composition may exhibit undesirable polishing performance and/or may not be cost effective and/or may lack stability. The polishing composition can comprise about 10 wt. % or less of the silica abrasive, for example, about 9 wt. % or less, about 8 wt. % or less, about 7 wt. % or less, about 6 wt. % or less, about 5 wt. % or less, about 4 wt. % or less, about 3 wt. % or less, about 2 wt. % or less, about 1 wt. % or less, about 0.9 wt. % or less, about 0.8 wt. % or less, about 0.7 wt. % or less, about 0.6 wt. % or less, or about 0.5 wt. % or less of the silica abrasive. Alternatively, or in addition, the polishing composition can comprise about 0.001 wt. % or more of the silica abrasive, for example, about 0.005 wt. % or more, about 0.01 wt. % or more, 0.05 wt. % or more, about 0.1 wt. % or more, about 0.2 wt. % or more, about 0.3 wt. % or more, about 0.4 wt. % or more, about 0.5 wt. % or more, or about 1 wt. % or more of silica abrasive. Thus, the polishing composition can comprise silica abrasive in an amount bounded by any two of the aforementioned endpoints, as appropriate.

For example, in some embodiments, the silica abrasive can be present in the polishing composition in an amount of from about 0.001 wt. % to about 10 wt. % of the polishing composition, e.g., about 0.001 wt. % to about 8 wt. %, about 0.001 wt. % to about 6 wt. %, about 0.001 wt. % to about 5 wt. %, about 0.001 wt. % to about 4 wt. %, about 0.001 wt. % to about 2 wt. %, about 0.001 wt. % to about 1 wt. %, about 0.01 wt. % to about 10 wt. %, about 0.01 wt. % to about 8 wt. %, about 0.01 wt. % to about 6 wt. %, about 0.01 wt. % to about 5 wt. %, about 0.01 wt. % to about 4 wt. %, about 0.01 wt. % to about 2 wt. %, about 0.01 wt. % to about 1 wt. %, about 0.05 wt. % to about 10 wt. %, about 0.05 wt. % to about 8 wt. %, about 0.05 wt. % to about 6 wt. %, about 0.05 wt. % to about 5 wt. %, about 0.05 wt. % to about 4 wt. %, about 0.05 wt. % to about 2 wt. %, about 0.05 wt. % to about 1 wt. %, about 0.1 wt. % to about 10 wt. %, about 0.1 wt. % to about 8 wt. %, about 0.1 wt. % to about 6 wt. %, about 0.1 wt. % to about 5 wt. %, about 0.1 wt. % to about 4 wt. %, about 0.1 wt. % to about 2 wt. %, about 0.1 wt. % to about 1 wt. %, about 0.5 wt. % to about 10 wt. %, about 0.5 wt. % to about 8 wt. %, about 0.5 wt. % to about 5 wt. %, about 0.5 wt. % to about 4 wt. %, about 0.5 wt. % to about 2 wt. %, about 0.5 wt. % to about 1 wt. %, about 1 wt. % to about 10 wt. %, about 1 wt. % to about 8 wt. %, about 1 wt. % to about 6 wt. %, about 1 wt. % to about 5 wt. %, about 1 wt. % to about 4 wt. %, or about 1 wt. % to about 2 wt. %. In some embodiments, the polishing composition comprises about 0.001 wt. % to about 10 wt. % of the silica abrasive. In certain embodiments, the polishing composition comprises about 0.5 wt. % to about 10 wt. % of the silica abrasive.

The chemical-mechanical polishing composition comprises a buffering agent. The buffering agent preferably possesses an acceptable buffering capacity at the desired pH of the polishing composition. The buffering agent typically includes one or more acids and one or more salts of the acid in relative amounts sufficient to establish the pH of the chemical-mechanical polishing composition at a desired pH value (i.e., a pH of about 1 to about 7), and to maintain that pH within an acceptable range above and below the desired pH during the chemical-mechanical polishing process. For example, the buffering agent can comprise an organic acid (e.g., a carboxylic acid, a phosphonic acid, or the like) or an inorganic acid (e.g., a phosphoric acid or the like) capable of providing a suitable buffering capacity at a desired acidic pH value. In some embodiments, the organic acid comprises a carboxylic acid, a phosphonic acid, or a combination thereof. Non-limiting examples of suitable carboxylic acids include monocarboxylic acids (e.g., acetic acid, benzoic acid, phenylacetic acid, 1-naphthoic acid, 2-naphthoic acid, glycolic acid, formic acid, lactic acid, mandelic acid, and the like) and polycarboxylic acids (e.g., oxalic acid, malonic acid, succinic acid, adipic acid, tartaric acid, citric acid, maleic acid, fumaric acid, aspartic acid, glutamic acid, phthalic acid, isophthalic acid, terephthalic acid, 1,2,3,4-butanetetracarboxylic acid, itaconic acid, and the like), as well as amino acids (e.g., glycine, proline, asparagine, glutamine, glutamic acid, aspartic acid, phenylalanine, alanine, beta-alanine, and the like). Non-limiting examples of suitable organic phosphonic acids include, DEQUEST™ 2060 (i.e., diethylene triamine penta(methylene-phosphonic acid)), DEQUEST™ 7000 (i.e., 2-phosphonobutane-1,2,4-tricarboxylic acid), and DEQUEST™ 2010 (i.e., hydroxyethylidene-1,1-diphosphonic acid), all of which are available from Solutia, Inc., as well as phosphonoacetic acid, iminodi(methylphosphonic acid), and the like. In some embodiments, the buffering agent comprises acetic acid, 1-hydroxyethylidene-1,1-diphosphonic acid, an amino acid (e.g., glycine), or phosphoric acid. In certain embodiments, the buffering agent comprises acetic acid.

The buffering agent can be present in the polishing composition in any suitable amount. The polishing composition can comprise about 5 wt. % or less of the buffering agent, for example, about 4 wt. % or less, about 3 wt. % or less, about 2 wt. % or less, about 1.5 wt. % or less, about 1 wt. % or less, or about 0.5 wt. % or less of the buffering agent. Alternatively, or in addition, the polishing composition can comprise about 0.01 wt. % or more of the buffering agent, for example, about 0.05 wt. % or more, about 0.1 wt. % or more, or 0.5 wt. % or more of the buffering agent. Thus, the polishing composition can comprise the buffering agent in an amount bounded by any two of the aforementioned endpoints, as appropriate.

For example, in some embodiments, the buffering agent can be present in the polishing composition in an amount of from about 0.01 wt. % to about 5 wt. % of the polishing composition, e.g., about 0.01 wt. % to about 4 wt. %, about 0.01 wt. % to about 3 wt. %, about 0.01 wt. % to about 2 wt. %, about 0.01 wt. % to about 1.5 wt. %, about 0.01 wt. % to about 1 wt. %, about 0.01 wt. % to about 0.5 wt. %, about 0.05 wt. % to about 5 wt. %, about 0.05 wt. % to about 4 wt. %, about 0.05 wt. % to about 3 wt. %, about 0.05 wt. % to about 2 wt. %, about 0.05 wt. % to about 1.5 wt. %, about 0.05 wt. % to about 1 wt. %, about 0.05 wt. % to about 0.5 wt. %, about 0.1 wt. % to about 5 wt. %, about 0.1 wt. % to about 4 wt. %, about 0.1 wt. % to about 3 wt. %, about 0.1 wt. % to about 2 wt. %, about 0.1 wt. % to about 1.5 wt. %, about 0.1 wt. % to about 1 wt. %, about 0.1 wt. % to about 0.5 wt. %, about 0.5 wt. % to about 5 wt. %, about 0.5 wt. % to about 4 wt. %, about 0.5 wt. % to about 3 wt. %, about 0.5 wt. % to about 2 wt. %, about 0.5 wt. % to about 1.5 wt. %, or about 0.5 wt. % to about 1 wt. %. In some embodiments, the polishing composition comprises about 0.05 wt. % to about 2 wt. % of the buffering agent. In certain embodiments, the polishing composition comprises about 0.1 wt. % to about 0.5 wt. % of the buffering agent.

The chemical-mechanical polishing composition comprises water. The water can be any suitable water including, for example, deionized water or distilled water. In some embodiments, the chemical-mechanical polishing composition can further comprise one or more organic solvents in combination with the water. For example, the polishing composition can further comprise a hydroxylic solvent such as methanol or ethanol, a ketonic solvent, an amide solvent, a sulfoxide solvent, and the like. In certain embodiments, the chemical-mechanical polishing composition comprises pure water.

The chemical-mechanical polishing composition has a pH of about 1 to about 7 at the point-of-use. Thus, the chemical-mechanical polishing composition can have a pH of about 1 or more, e.g., about 1.5 or more, about 2 or more, about 2.2 or more, about 2.4 or more, about 2.6 or more, about 2.8 or more, about 3 or more, about 3.2 or more, about 3.4 or more, about 3.6 or more, about 3.8 or more, or about 4 or more. Alternatively, or in addition, the chemical-mechanical polishing composition can have a pH of about 7 or less, e.g., about 6.5 or less, about 6 or less, about 5.5 or less, about 5 or less, about 4.8 or less, about 4.6 or less, about 4.4 or less, about 4.2 or less, or about 4 or less. Thus, the chemical-mechanical polishing composition can have a pH bounded by any two of the aforementioned endpoints. For example the chemical-mechanical polishing composition can have a pH of about 1 to about 6, e.g., about 1 to about 5, about 2 to about 6, about 2 to about 5, about 2.2 to about 5, about 2.2 to about 4.8, about 2.4 to about 4.8, about 2.4 to about 4.6, about 2.4 to about 4.4, about 2.4 to about 4.2, about 1 to about 4, about 1.5 to about 4, or about 2 to about 4 at the point-of-use. In some embodiments, the polishing composition has a pH of about 2 to about 6. In certain embodiments, the polishing composition has a pH of about 2 to about 4.

The chemical-mechanical polishing composition can comprise one or more compounds capable of adjusting (i.e., that adjust) the pH of the polishing composition (i.e., pH adjusting compounds). The pH of the polishing composition can be adjusted using any suitable compound capable of adjusting the pH of the polishing composition. The pH adjusting compound desirably is water-soluble and compatible with the other components of the polishing composition. Non-limiting examples of suitable acids for adjusting the pH of the polishing composition include nitric acid, sulfuric acid, phosphoric acid, and organic acids such as formic acid and acetic acid. Non-limiting examples of suitable bases for adjusting the pH of the polishing composition include sodium hydroxide, potassium hydroxide, and ammonium hydroxide. In some embodiments, the buffering agent is sufficient to adjust the pH of the polishing composition.

In some embodiments, the chemical-mechanical polishing composition further comprises an oxidizing agent. The oxidizing agent can be any suitable oxidizing agent. Without wishing to be bound by any particular theory, it is believed that the oxidizing agent increases the removal rate of silicon carbide when used to polish a substrate comprising the same. A non-limiting example of a suitable oxidizing agent includes oxone, cerium ammonium nitrate, a peroxide (e.g., hydrogen peroxide), a periodate (e.g., sodium periodate or potassium periodate), an iodate (e.g., sodium iodate, potassium iodate, or ammonium iodate), a persulfate (e.g., sodium persulfate, potassium persulfate, or ammonium persulfate), a chlorate (e.g., sodium chlorate or potassium chlorate), a chromate (e.g., sodium chromate or potassium chromate), a permanganate (e.g., sodium permanganate, potassium permanganate, or ammonium permanganate), a bromate (e.g., sodium bromate or potassium bromate), a perbromate (e.g., sodium perbromate or potassium perbromate), a ferrate (e.g., potassium ferrate), a perrhenate (e.g., ammonium perrhenate), a perruthenate (e.g., tetrapropylammonium perruthenate), and a combination thereof. In some embodiments, the oxidizing agent is hydrogen peroxide. The polishing composition can comprise any suitable amount of the oxidizing agent. For example, the polishing composition can comprise about 0.1 wt. % to about 5 wt. % of the oxidizing agent (e.g., about 0.5 wt. % to about 3 wt. % or about 1 wt. % to about 3 wt. % of the oxidizing agent).

In some embodiments, the chemical-mechanical polishing composition further comprises one or more additives such as, for example, conditioners, acids (e.g., sulfonic acids), complexing agents (e.g., anionic polymeric complexing agents), chelating agents, biocides, scale inhibitors, dispersants, and/or conductivity adjustors. In certain embodiments, the composition further comprises a biocide, a conductivity adjustor, or a combination thereof. A biocide, when present, can be any suitable biocide and can be present in the polishing composition in any suitable amount. A suitable biocide is an isothiazolinone biocide. Typically, the polishing composition comprises about 1 ppm to about 200 ppm biocide (e.g., about 1 ppm to about 100 ppm or about 1 ppm to about 50 ppm), preferably about 10 ppm to about 20 ppm biocide. A conductivity adjustor, when present, can be any suitable conductivity adjustor and can be present in the polishing composition in any suitable amount. Suitable conductivity adjustors include, but are not limited to, potassium nitrate and potassium sulfate. Typically, the polishing composition comprises about 1 ppm to about 2000 ppm of the conductivity adjustor, preferably about 10 ppm to about 1000 ppm of the conductivity adjustor.

In some embodiments, the chemical-mechanical polishing composition is free of surfactants and oxidizing agents. As used herein, the phrase “free of surfactants” means (a) that the composition does not contain a surfactant or (b) that the composition has no more than trace amounts of surfactants, which amounts are insufficient to affect the surface tension or contact angle of the composition. As used herein, the phrase “free of oxidizing agents” means (a) that the composition does not contain an oxidizing agent or (b) that the composition includes no more than trace contaminant amounts of oxidizing materials, which amounts are insufficient to affect any metal removal rate obtainable with the composition during chemical-mechanical polishing.

In certain embodiments, the chemical-mechanical polishing composition does not contain one or more of a piperazine compound, a 4-morpholine compound, an amino sulfonic acid compound, a substituted amine compound, a tertiary amine compound, a bis-amine compound, or salts thereof. As used herein, the phrase “does not contain” means that the polishing composition includes no more than trace contaminant amounts of the recited compounds, which amounts are insufficient to affect any SiC, SiN, or SiO removal rates obtainable with the polishing composition during polishing. In certain embodiments, the polishing composition does not contain a substituted 4-morpholine derivative such as 3-(N-morpholino) propanesulfonic acid (MOPS), 4-morpholineethanesulfonic acid (MES), β-hydroxy-4-morpholinepropanesulfonic acid (MOPSO), and combinations thereof. In certain embodiments, the polishing composition does not contain an amino sulfonic acid such as 2-[(2-hydroxy-1,1-bis(hydroxymethyl)ethyl)amino]ethanesulfonic acid (TES), N-[tris(hydroxymethyl)methyl]-3-aminopropanesulfonic acid (TAPS), N-tris(hydroxymethyl)methyl-4-aminobutanesulfonic acid (TABS), N-(2-acetamido)-2-aminoethanesulfonic acid (ACES), N,N-bis(2-hydroxyethyl)-2-aminoethanesulfonic acid (BES), 3-(cyclohexylamino)-1-propanesulfonic acid (CAPS), 2-(cyclohexylamino) ethanesulfonic acid (CHES), and combinations thereof. In certain embodiments, the polishing composition does not contain a substituted amine compound such as 2-hydroxy-3-[tris(hydroxymethyl)methylamino]-1-propanesulfonic acid (TAPSO), N-[tris(hydroxymethyl)methyl]glycine (TRICINE), N,N-bis(2-hydroxyethyl)glycine (BICINE), N-(2-acetamido)iminodiacetic acid (ADA), 2,2-bis(hydroxymethyl)−2,2′,2″-nitrilotriethanol (BIS-TRIS), 3-(cyclohexylamino)-2-hydroxy-1-propanesulfonic acid (CAPSO), 3-(N,N-bis [2-hydroxyethyl]amino)-2-hydroxypropanesulfonic acid (DIPSO), and combinations thereof. In certain embodiments, the polishing composition does not contain a substituted bis-amine compound such as 1,3-bis [tris(hydroxymethyl)methylamino] propane (BIS-TRIS PROPANE).

The polishing composition can be produced by any suitable technique, many of which are known to those skilled in the art. The polishing composition can be prepared in a batch or continuous process. Generally, the polishing composition is prepared by combining the components of the polishing composition in any order. The term “component” as used herein includes individual ingredients (e.g., silica abrasive, buffering agent, and/or any other optional additive, etc.) as well as any combination of ingredients (e.g., silica abrasive, buffering agent, and/or any other optional additive, etc.).

For example, the polishing composition can be prepared by (i) providing all or a portion of the liquid carrier, (ii) dispersing the silica abrasive, buffering agent, and/or any other optional additive, etc., using any suitable means for preparing such a dispersion, (iii) adjusting the pH of the dispersion as appropriate, and (iv) optionally adding suitable amounts of any other optional components and/or additives to the mixture.

Alternatively, the polishing composition can be prepared by (i) providing one or more components (e.g., buffering agent and/or any other optional additive) in a silica abrasive slurry, (ii) providing one or more components in an additive solution (e.g., buffering agent and/or any other optional additive), (iii) combining the silica abrasive slurry and the additive solution to form a mixture, (iv) optionally adding suitable amounts of any other optional additives to the mixture, and (v) adjusting the pH of the mixture as appropriate.

The polishing composition can be supplied as a one-package system comprising a silica abrasive, buffering agent, and/or any other optional additive, and water. Alternatively, the polishing composition of the invention can be supplied as a two-package system comprising a silica abrasive slurry in a first package and an additive solution in a second package, wherein the silica abrasive slurry consists essentially of, or consists of, a silica abrasive, and water, and wherein the additive solution consists essentially of, or consists of, buffering agent and/or any other optional additive. The two-package system allows for the adjustment of polishing composition characteristics by changing the blending ratio of the two packages, i.e., the silica abrasive slurry and the additive solution.

Various methods can be employed to utilize such a two-package polishing system. For example, the silica abrasive slurry and additive solution can be delivered to the polishing table by different pipes that are joined and connected at the outlet of supply piping. The silica abrasive slurry and additive solution can be mixed shortly or immediately before polishing, or can be supplied simultaneously on the polishing table. Furthermore, when mixing the two packages, deionized water can be added, as desired, to adjust the polishing composition and resulting substrate polishing characteristics.

Similarly, a three-, four-, or more package system can be utilized in connection with the invention, wherein each of multiple containers contains different components of the inventive chemical-mechanical polishing composition, one or more optional components, and/or one or more of the same components in different concentrations.

In order to mix components contained in two or more storage devices to produce the polishing composition at or near the point-of-use, the storage devices typically are provided with one or more flow lines leading from each storage device to the point-of-use of the polishing composition (e.g., the platen, the polishing pad, or the substrate surface). As utilized herein, the term “point-of-use” refers to the point at which the polishing composition is applied to the substrate surface (e.g., the polishing pad or the substrate surface itself). By the term “flow line” is meant a path of flow from an individual storage container to the point-of-use of the component stored therein. The flow lines can each lead directly to the point-of-use, or two or more of the flow lines can be combined at any point into a single flow line that leads to the point-of-use. Furthermore, any of the flow lines (e.g., the individual flow lines or a combined flow line) can first lead to one or more other devices (e.g., pumping device, measuring device, mixing device, etc.) prior to reaching the point-of-use of the component(s).

The components of the polishing composition can be delivered to the point-of-use independently (e.g., the components are delivered to the substrate surface whereupon the components are mixed during the polishing process), or one or more of the components can be combined before delivery to the point-of-use, e.g., shortly or immediately before delivery to the point-of-use. Components are combined “immediately before delivery to the point-of-use” if the components are combined about 5 minutes or less prior to being added in mixed form onto the platen, for example, about 4 minutes or less, about 3 minutes or less, about 2 minutes or less, about 1 minute or less, about 45 seconds or less, about 30 seconds or less, about 10 seconds or less prior to being added in mixed form onto the platen, or simultaneously to the delivery of the components at the point-of-use (e.g., the components are combined at a dispenser). Components also are combined “immediately before delivery to the point-of-use” if the components are combined within 5 m of the point-of-use, such as within 1 m of the point-of-use or even within 10 cm of the point-of-use (e.g., within 1 cm of the point-of-use).

When two or more of the components of the polishing composition are combined prior to reaching the point-of-use, the components can be combined in the flow line and delivered to the point-of-use without the use of a mixing device. Alternatively, one or more of the flow lines can lead into a mixing device to facilitate the combination of two or more of the components. Any suitable mixing device can be used. For example, the mixing device can be a nozzle or jet (e.g., a high-pressure nozzle or jet) through which two or more of the components flow. Alternatively, the mixing device can be a container-type mixing device comprising one or more inlets by which two or more components of the polishing slurry are introduced to the mixer, and at least one outlet through which the mixed components exit the mixer to be delivered to the point-of-use, either directly or via other elements of the apparatus (e.g., via one or more flow lines). Furthermore, the mixing device can comprise more than one chamber, each chamber having at least one inlet and at least one outlet, wherein two or more components are combined in each chamber. If a container-type mixing device is used, the mixing device preferably comprises a mixing mechanism to further facilitate the combination of the components. Mixing mechanisms are generally known in the art and include stirrers, blenders, agitators, paddled baffles, gas sparger systems, vibrators, etc.

The polishing composition also can be provided as a concentrate which is intended to be diluted with an appropriate amount of water prior to use. In such an embodiment, the polishing composition concentrate comprises the components of the polishing composition in amounts such that, upon dilution of the concentrate with an appropriate amount of water, each component of the polishing composition will be present in the polishing composition in an amount within the appropriate range recited above for each component. For example, the buffering agent and/or any other optional additive can each be present in the concentrate in an amount that is about 2 times (e.g., about 3 times, about 4 times, or about 5 times) greater than the concentration recited above for each component so that, when the concentrate is diluted with an equal volume of water (e.g., 2 equal volumes water, 3 equal volumes of water, or 4 equal volumes of water, respectively), each component will be present in the polishing composition in an amount within the ranges set forth above for each component. Furthermore, as will be understood by those of ordinary skill in the art, the concentrate can contain an appropriate fraction of the water present in the final polishing composition in order to ensure that the buffering agent and/or any other optional additive are at least partially or fully dissolved in the concentrate.

The invention further provides a method of chemically-mechanically polishing a substrate comprising: providing a substrate; providing a polishing pad; providing a chemical-mechanical polishing composition comprising: (a) a silica abrasive; (b) a buffering agent; and (c) water, wherein the polishing composition has a pH of about 1 to about 7 and the silica abrasive has a zeta potential of about −10 mV to about −50 mV in the polishing composition; contacting the substrate with the polishing pad and the chemical-mechanical polishing composition; and moving the polishing pad and the chemical-mechanical polishing composition relative to the substrate to abrade at least a portion of the substrate to polish the substrate.

The chemical-mechanical polishing composition can be used to polish any suitable substrate and is especially useful for polishing substrates comprising at least one layer (typically a surface layer) comprised of silicon nitride or silicon carbide. Suitable substrates include wafers used in the semiconductor industry. The wafers typically comprise or consist of, for example, a metal, metal oxide, metal nitride, metal composite, metal alloy, a low dielectric material, or combinations thereof. The method of the invention is particularly useful for polishing substrates comprising silicon carbide, silicon nitride, and/or silicon oxide, i.e., polishing substrates comprising any one, two, or three of silicon carbide, silicon nitride, and silicon oxide. In some embodiments, the polishing substrate comprises silicon carbide and/or silicon nitride in combination with silicon oxide.

In some embodiments, the substrate comprises silicon nitride on a surface of the substrate, and wherein at least a portion of the silicon nitride on a surface of the substrate is abraded at a silicon nitride removal rate (A/min) to polish the substrate. The silicon nitride can be any suitable silicon nitride and can be applied to the surface by any suitable method (e.g., low pressure chemical vapor deposition (LPCVD) or plasma enhanced chemical vapor deposition (PECVD)). The chemical-mechanical polishing composition of the invention desirably exhibits a high removal rate when polishing a substrate comprising silicon nitride according to a method of the invention. For example, when polishing substrates comprising silicon nitride in accordance with an embodiment of the invention, the polishing composition desirably exhibits a removal rate of the silicon nitride of about 400 Å/min or higher, for example, about 500 Å/min or higher, about 600 Å/min or higher, about 700 Å/min or higher, about 800 Å/min or higher, about 900 Å/min or higher, about 1,000 Å/min or higher, about 1,100 Å/min or higher, about 1,200 Å/min or higher, about 1,500 Å/min or higher, about 2,000 Å/min or higher, about 3,000 Å/min or higher, or about 4,000 Å/min or higher.

In some embodiments, the substrate comprises silicon nitride and silicon oxide. The silicon oxide can be any suitable silicon oxide, many forms of which are known in the art. Suitable types of silicon oxide include, but are not limited to, silicon oxide films derived from tetraethyl orthosilicate (TEOS), borophosphosilicate glass (BPSG), plasma enhanced tetraethyl orthosilicate (PETEOS), thermal oxide, undoped silicate glass, and high-density plasma (HDP) oxide. In certain embodiments, the substrate comprises silicon oxide on a surface of the substrate, and no silicon oxide on a surface of the substrate is abraded. In other embodiments, the substrate comprises silicon oxide on a surface of the substrate, and at least a portion of the silicon oxide on a surface of the substrate is abraded at a silicon oxide removal rate (A/min) to polish the substrate. The chemical-mechanical polishing composition of the invention desirably exhibits a low removal rate when polishing a substrate comprising silicon oxide according to a method of the invention. For example, when polishing substrates comprising silicon oxide in accordance with an embodiment of the invention, the polishing composition desirably exhibits a removal rate of the silicon oxide of about 200 Å/min or lower, for example, about 150 Å/min or lower, about 100 Å/min or lower, about 90 Å/min or lower, about 80 Å/min or lower, about 70 Å/min or lower, about 60 Å/min or lower, about 50 Å/min or lower, about 40 Å/min or lower, or about 30 Å/min or lower.

Thus, when used to polish a substrate comprising a silicon nitride layer and a silicon oxide layer, the polishing composition desirably exhibits selectivity for the polishing of the silicon nitride layer over the silicon oxide layer. In other words, the silicon nitride removal rate (A/min) is greater than the silicon oxide removal rate (Å/min). When desirable, the chemical-mechanical polishing composition of the invention can be used to polish a substrate with a silicon nitride to silicon oxide polishing selectivity of about 5:1 or higher (e.g., about 10:1 or higher, about 15:1 or higher, about 25:1 or higher, about 50:1 or higher, about 100:1 or higher, or about 150:1 or higher). In some embodiments, the silicon nitride removal rate (A/min) is at least 10 times greater (e.g., 10 to 200 times greater, 10 to 100 times greater, or 10 to 50 times greater) than the silicon oxide removal rate (Å/min). In some embodiments, the silicon nitride removal rate (Å/min) is at least 20 times greater (e.g., 20 to 200 times greater, 20 to 100 times greater, or 20 to 50 times greater) than the silicon oxide removal rate (Å/min). In certain embodiments, the silicon nitride removal rate (Å/min) is at least 30 times greater (e.g., 30 to 200 times greater, 30 to 100 times greater, or 30 to 50 times greater) than the silicon oxide removal rate (Å/min).

In some embodiments, the substrate comprises silicon carbide on a surface of the substrate, and wherein at least a portion of the silicon carbide on a surface of the substrate is abraded at a silicon carbide removal rate (Å/min) to polish the substrate. The silicon carbide can be any suitable silicon carbide, many forms of which are known in the art, and can be applied to the surface by any suitable method (e.g., low pressure chemical vapor deposition (LPCVD) or plasma enhanced chemical vapor deposition (PECVD)). In addition, the silicon carbide can have any suitable polytype, many of which are known in the art. The chemical-mechanical polishing composition of the invention desirably exhibits a high removal rate when polishing a substrate comprising silicon carbide according to a method of the invention.

For example, when polishing substrates comprising silicon carbide in accordance with an embodiment of the invention, the polishing composition desirably exhibits a removal rate of the carbon-based film of about 400 Å/min or higher, for example, about 500 Å/min or higher, about 600 Å/min or higher, about 700 Å/min or higher, about 800 Å/min or higher, about 900 Å/min or higher, about 1,000 Å/min or higher, about 1,100 Å/min or higher, about 1,200 Å/min or higher, about 1,500 Å/min or higher, about 2,000 Å/min or higher, about 3,000 Å/min or higher, or about 4,000 Å/min or higher.

In some embodiments, the substrate comprises silicon carbide and silicon oxide. The silicon oxide can be any suitable silicon oxide, many forms of which are known in the art. Suitable types of silicon oxide include, but are not limited to, silicon oxide derived from tetraethyl orthosilicate (TEOS), borophosphosilicate glass (BPSG), plasma enhanced tetraethyl orthosilicate (PETEOS), thermal oxide, undoped silicate glass, and high-density plasma (HDP) oxide. In certain embodiments, the substrate comprises silicon oxide on a surface of the substrate, and no silicon oxide on a surface of the substrate is abraded. In other embodiments, the substrate comprises silicon oxide on a surface of the substrate, and at least a portion of the silicon oxide on a surface of the substrate is abraded at a silicon oxide removal rate (Å/min) to polish the substrate. The chemical-mechanical polishing composition of the invention desirably exhibits a low removal rate when polishing a substrate comprising silicon oxide according to a method of the invention. For example, when polishing substrates comprising silicon oxide in accordance with an embodiment of the invention, the polishing composition desirably exhibits a removal rate of the silicon oxide of about 200 Å/min or lower, for example, about 150 Å/min or lower, about 100 Å/min or lower, about 90 Å/min or lower, about 80 Å/min or lower, about 70 Å/min or lower, about 60 Å/min or lower, about 50 Å/min or lower, about 40 Å/min or lower, or about 30 Å/min or lower.

Thus, when used to polish a substrate comprising a silicon carbide layer and a silicon oxide layer, the polishing composition desirably exhibits selectivity for the polishing of the silicon carbide layer over the silicon oxide layer. In other words, the silicon carbide removal rate (A/min) is greater than the silicon oxide removal rate (Å/min). When desirable, the chemical-mechanical polishing composition of the invention can be used to polish a substrate with a silicon carbide to silicon oxide polishing selectivity of about 5:1 or higher (e.g., about 10:1 or higher, about 15:1 or higher, about 25:1 or higher, about 50:1 or higher, about 100:1 or higher, or about 150:1 or higher). In some embodiments, the silicon carbide removal rate (Å/min) is at least 10 times greater (e.g., 10 to 200 times greater, 10 to 100 times greater, or 10 to 50 times greater) than the silicon oxide removal rate (Å/min). In some embodiments, the silicon carbide removal rate (Å/min) is at least 20 times greater (e.g., 20 to 200 times greater, 20 to 100 times greater, or 20 to 50 times greater) than the silicon oxide removal rate (Å/min). In certain embodiments, the silicon carbide removal rate (Å/min) is at least 30 times greater (e.g., 30 to 200 times greater, 30 to 100 times greater, or 30 to 50 times greater) than the silicon oxide removal rate (Å/min).

In some embodiments, the substrate comprises silicon carbide, silicon nitride, and silicon oxide. When used to polish a substrate comprising a silicon carbide layer, a silicon nitride layer, and a silicon oxide layer, the polishing composition desirably exhibits selectivity for the polishing of the silicon carbide and silicon nitride layers over the silicon oxide layer. In other words, the silicon carbide removal rate (A/min) and the silicon nitride removal rate (Å/min) are greater than the silicon oxide removal rate (Å/min).

The polishing composition of the invention desirably exhibits low particle defects when polishing a substrate, as determined by suitable techniques. Particle defects on a substrate polished with the inventive polishing composition can be determined by any suitable technique. For example, laser light scattering techniques, such as dark field normal beam composite (DCN) and dark field oblique beam composite (DCO), can be used to determine particle defects on polished substrates. Suitable instrumentation for evaluating particle defectivity is available from, for example, KLA-Tencor (e.g., SURFSCAN™ SPI instruments operating at a 120 nm threshold or at 160 nm threshold).

The chemical-mechanical polishing composition and method of the invention are particularly suited for use in conjunction with a chemical-mechanical polishing apparatus. Typically, the apparatus comprises a platen, which, when in use, is in motion and has a velocity that results from orbital, linear, or circular motion, a polishing pad in contact with the platen and moving with the platen when in motion, and a carrier that holds a substrate to be polished by contacting and moving the substrate relative to the surface of the polishing pad. The polishing of the substrate takes place by the substrate being placed in contact with the polishing pad and the polishing composition of the invention, and then the polishing pad moving relative to the substrate, so as to abrade at least a portion of the substrate to polish the substrate.

A substrate can be polished with the chemical-mechanical polishing composition using any suitable polishing pad (e.g., polishing surface). Suitable polishing pads include, for example, woven and non-woven polishing pads. Moreover, suitable polishing pads can comprise any suitable polymer of varying density, hardness, thickness, compressibility, ability to rebound upon compression, and compression modulus. Suitable polymers include, for example, polyvinylchloride, polyvinylfluoride, nylon, fluorocarbon, polycarbonate, polyester, polyacrylate, polyether, polyethylene, polyamide, polyurethane, polystyrene, polypropylene, coformed products thereof, and mixtures thereof. Soft polyurethane polishing pads are particularly useful in conjunction with the inventive polishing method. Typical pads include but are not limited to SURFIN™ 000, SURFIN™ SSW1, SPM3100 (commercially available from, for example, Eminess Technologies), POLITEX™, EPIC™ D100 pad (commercially available from Entegris Corporation), IC1010 pad (commercially available from Dow, Inc.) and Fujibo POLYPAS™ 27.

Desirably, the chemical-mechanical polishing apparatus further comprises an in situ polishing endpoint detection system, many of which are known in the art. Techniques for inspecting and monitoring the polishing process by analyzing light or other radiation reflected from a surface of the substrate being polished are known in the art. Such methods are described, for example, in U.S. Pat. Nos. 5,196,353, 5,433,651, 5,609,511. U.S. Pat. Nos. 5,643,046, 5,658,183, 5,730,642, 5,838,447, 5,872,633. U.S. Pat. Nos. 5,893,796, 5,949,927, and 5,964,643. Desirably, the inspection or monitoring of the progress of the polishing process with respect to a substrate being polished enables the determination of the polishing end-point, i.e., the determination of when to terminate the polishing process with respect to a particular substrate.

Aspects, including embodiments, of the invention described herein may be beneficial alone or in combination, with one or more other aspects or embodiments. Without limiting the foregoing description, certain non-limiting embodiments of the disclosure numbered 1-56 are provided below. As will be apparent to those of skill in the art upon reading this disclosure, each of the individually numbered embodiments may be used or combined with any of the preceding or following individually numbered embodiments. This is intended to provide support for all such combinations of embodiments and is not limited to combinations of embodiments explicitly provided below:

### EMBODIMENTS

(1) In embodiment (1) is presented a chemical-mechanical polishing composition comprising:
(a) a silica abrasive,
(b) a buffering agent, and
(c) water, wherein the polishing composition has a pH of about 1 to about 7 and the silica abrasive has a zeta potential of about −10 mV to about −50 mV in the polishing composition.

(2) In embodiment (2) is presented the polishing composition of embodiment (1), wherein the polishing composition comprises about 0.001 wt. % to about 10 wt. % of the silica abrasive.

(3) In embodiment (3) is presented the polishing composition of embodiment (1) or embodiment (2), wherein the polishing composition comprises about 0.5 wt. % to about 10 wt. % of the silica abrasive.

(4) In embodiment (4) is presented the polishing composition of any one of embodiments (1)-(3), wherein the silica abrasive is a silicate-based silica abrasive.

(5) In embodiment (5) is presented the polishing composition of any one of embodiments (1)-(4), wherein the polishing composition has a pH of about 2 to about 6.

(6) In embodiment (6) is presented the polishing composition of any one of embodiments (1)-(5), wherein the polishing composition has a pH of about 2 to about 4.

(7) In embodiment (7) is presented the polishing composition of any one of embodiments (1)-(6), where in the buffering agent comprises an organic acid.

(8) In embodiment (8) is presented the polishing composition of embodiment (7), wherein the organic acid comprises a carboxylic acid, a phosphonic acid, or a combination thereof.

(9) In embodiment (9) is presented the polishing composition of embodiment (7), wherein the organic acid comprises acetic acid.

(10) In embodiment (10) is presented the polishing composition of embodiment (7), wherein the organic acid comprises 1-hydroxyethylidene-1,1-diphosphonic acid.

(11) In embodiment (11) is presented the polishing composition of embodiment (7), wherein the organic acid comprises an amino acid.

(12) In embodiment (12) is presented the polishing composition of any one of embodiments (1)-(6), wherein the buffering agent comprises an inorganic acid.

(13) In embodiment (13) is presented the polishing composition of embodiment (12), wherein the inorganic acid is a phosphoric acid.

(14) In embodiment (14) is presented the polishing composition of any one of embodiments (1)-(13), wherein the polishing composition comprises about 0.05 wt. % to about 2 wt. % of the buffering agent.

(15) In embodiment (15) is presented the polishing composition of any one of embodiments (1)-(14), wherein the polishing composition comprises about 0.1 wt. % to about 0.5 wt. % of the buffering agent.

(16) In embodiment (16) is presented the polishing composition of any one of embodiments (1)-(15), wherein the silica abrasive has a zeta potential of about −15 mV to about −35 mV in the polishing composition.

(17) In embodiment (17) is presented the polishing composition of any one of embodiments (1)-(16), wherein the silica abrasive has a zeta potential of about −20 mV to about −30 mV in the polishing composition.

(18) In embodiment (18) is presented the polishing composition of any one of embodiments (1)-(17), wherein the silica abrasive has an average particle size of about 20 nm to about 150 nm.

(19) In embodiment (19) is presented the polishing composition of any one of embodiments (1)-(18), wherein the silica abrasive has an average particle size of about 30 nm to about 50 nm.

(20) In embodiment (20) is presented the polishing composition of any one of embodiments (1)-(19), wherein the silica abrasive is not doped with a metal.

(21) In embodiment (21) is presented the polishing composition of any one of embodiments (1)-(20), wherein the polishing composition further comprises a biocide.

(22) In embodiment (22) is presented a method of chemically-mechanically polishing a substrate comprising:
providing a substrate,
providing a polishing pad;
providing a chemical-mechanical polishing composition comprising:
(a) a silica abrasive;
(b) a buffering agent; and
(c) water,
wherein the polishing composition has a pH of about 1 to about 7 and the silica abrasive has a zeta potential of about −10 mV to about −50 mV in the polishing composition;
contacting the substrate with the polishing pad and the chemical-mechanical polishing composition; and
moving the polishing pad and the chemical-mechanical polishing composition relative to the substrate to abrade at least a portion of the substrate to polish the substrate.

(23) In embodiment (23) is presented the method of embodiment (22), wherein the polishing composition comprises about 0.001 wt. % to about 10 wt. % of the silica abrasive.

(24) In embodiment (24) is presented the method of embodiment (22) or embodiment (23), wherein the polishing composition comprises about 0.5 wt. % to about 10 wt. % of the silica abrasive.

(25) In embodiment (25) is presented the method of any one of embodiments (22)-(24), wherein the silica abrasive is a silicate-based silica abrasive.

(26) In embodiment (26) is presented the method of any one of embodiments (22)-(25), wherein the polishing composition has a pH of about 2 to about 6.

(27) In embodiment (27) is presented the method of any one of embodiments (22)-(26), wherein the polishing composition has a pH of about 2 to about 4.

(28) In embodiment (28) is presented the method of any one of embodiments (22)-(27), where in the buffering agent comprises an organic acid.

(29) In embodiment (29) is presented the method of embodiment (28), wherein the organic acid comprises a carboxylic acid, a phosphonic acid, or a combination thereof.

(30) In embodiment (30) is presented the method of embodiment (28), wherein the organic acid comprises acetic acid.

(31) In embodiment (31) is presented the method of embodiment (28), wherein the organic acid comprises 1-hydroxyethylidene-1,1-diphosphonic acid.

(32) In embodiment (32) is presented the method of embodiment (28), wherein the organic acid comprises an amino acid.

(33) In embodiment (33) is presented the method of any one of embodiments (22)-(27), wherein the buffering agent comprises an inorganic acid.

(34) In embodiment (34) is presented the method of embodiment (33), wherein the inorganic acid is a phosphoric acid.

(35) In embodiment (35) is presented the method of any one of embodiments (22)-(34), wherein the polishing composition comprises about 0.05 wt. % to about 2 wt. % of the buffering agent.

(36) In embodiment (36) is presented the method of any one of embodiments (22)-(35), wherein the polishing composition comprises about 0.1 wt. % to about 0.5 wt. % of the buffering agent.

(37) In embodiment (37) is presented the method of any one of embodiments (22)-(36), wherein the silica abrasive has a zeta potential of about −15 mV to about −35 mV in the polishing composition.

(38) In embodiment (38) is presented the method of any one of embodiments (22)-(37), wherein the silica abrasive has a zeta potential of about −20 mV to about −30 mV in the polishing composition.

(39) In embodiment (39) is presented the method of any one of embodiments (22)-(38), wherein the silica abrasive has an average particle size of about 20 nm to about 150 nm.

(40) In embodiment (40) is presented the method of any one of embodiments (22)-(39), wherein the silica abrasive has an average particle size of about 30 nm to about 50 nm.

(41) In embodiment (41) is presented the method of any one of embodiments (22)-(40), wherein the silica abrasive is not doped with a metal.

(42) In embodiment (42) is presented the method of any one of embodiments (22)-(41), wherein the polishing composition further comprises a biocide.

(43) In embodiment (43) is presented the method of any one of embodiments (24)-(42), wherein the substrate comprises silicon nitride on a surface of the substrate, and wherein at least a portion of the silicon nitride on a surface of the substrate is abraded at a silicon nitride removal rate (Å/min) to polish the substrate.

(44) In embodiment (44) is presented the method of embodiment (43), wherein the substrate further comprises silicon oxide on a surface of the substrate, and wherein no silicon oxide on a surface of the substrate is abraded.

(45) In embodiment (45) is presented the method of embodiment (43), wherein the substrate further comprises silicon oxide on a surface of the substrate, and wherein at least a portion of the silicon oxide on a surface of the substrate is abraded at a silicon oxide removal rate (Å/min) to polish the substrate.

(46) In embodiment (46) is presented the method of embodiment (45), wherein the silicon nitride removal rate (A/min) is greater than the silicon oxide removal rate (Å/min).

(47) In embodiment (47) is presented the method of embodiment (46), wherein the silicon nitride removal rate (A/min) is at least 10 times greater than the silicon oxide removal rate (Å/min).

(48) In embodiment (48) is presented the method of embodiment (47), wherein the silicon nitride removal rate (A/min) is at least 20 times greater than the silicon oxide removal rate (Å/min).

(49) In embodiment (49) is presented the method of embodiment (48), wherein the silicon nitride removal rate (A/min) is at least 30 times greater than the silicon oxide removal rate (Å/min).

(50) In embodiment (50) is presented the method of any one of embodiments (24)-(49), wherein the substrate comprises silicon carbide on a surface of the substrate, and wherein at least a portion of the silicon carbide on a surface of the substrate is abraded at a silicon carbide removal rate (Å/min) to polish the substrate.

(51) In embodiment (51) is presented the method of embodiment (50), wherein the substrate further comprises silicon oxide on a surface of the substrate, and wherein no silicon oxide on a surface of the substrate is abraded.

(52) In embodiment (52) is presented the method of embodiment (50), wherein the substrate further comprises silicon oxide on a surface of the substrate, and wherein at least a portion of the silicon oxide on a surface of the substrate is abraded at a removal rate (Å/min) to polish the substrate.

(53) In embodiment (53) is presented the method of embodiment (52), wherein the silicon carbide removal rate (Å/min) is greater than the silicon oxide removal rate (Å/min).

(54) In embodiment (54) is presented the method of embodiment (53), wherein the silicon carbide removal rate (A/min) is at least 10 times greater than the silicon oxide removal rate (Å/min).

(55) In embodiment (55) is presented the method of embodiment (54), wherein the silicon carbide removal rate (Å/min) is at least 20 times greater than the silicon oxide removal rate (Å/min).

(56) In embodiment (56) is presented the method of embodiment (55), wherein the silicon carbide removal rate (Å/min) is at least 30 times greater than the silicon oxide removal rate (Å/min).

### EXAMPLES

These following examples further illustrate the invention but, of course, should not be construed as in any way limiting its scope.

The following abbreviations are used throughout the Examples: removal rate (RR); silicon carbide (SiC); silicon nitride (SiN); and silicon oxide derived from tetraethyl orthosilicate (TEOS).

### Example 1

This example shows the plasma enhanced (PE) chemical vapor deposited silicon nitride (SiN) and tetraethyl orthosilicate-derived silicon oxide removal rate (in Å/min) exhibited by aluminum-doped silicate abrasive, tetramethyl orthosilicate abrasive, and surface modified silicate-based silica abrasive, as a function of polishing conditions.

Silica Abrasives 1A (aluminum-doped silicate abrasive having a zeta potential of approximately-12.1 mV and a particle size of 36 nm), 1B (tetramethyl orthosilicate abrasive having a zeta potential of approximately-21.6 mV and a particle size of 64 nm), 1C (surface modified silicate-based silica abrasive having a zeta potential of approximately-15.2 mV and a particle size of 39 nm), and 1D (surface modified silicate-based silica abrasive having a zeta potential of approximately-16.3 mV and a particle size of 39 nm) were formulated in polishing compositions comprising 6 wt. % silica abrasive and 0.3 wt. % acetic acid at a pH of 3.3. The zeta potential of the silica abrasive was measured using a Malvern Instrument (Malvern, UK). The resulting polishing compositions were diluted 6×, 16×, and 30× with deionized water prior to polishing with Condition A, Condition B, or Condition C.

Condition A: Wafers (300 mm) containing TEOS and plasma enhanced (PE) SiN were cut into coupons and polished using a Logitech 2 benchtop polishing machine at 2 PSI (13.8 kPa) downforce using a Fujibo H700 pad conditioned with a product commercially identified as A82 (3M, St. Paul, MN). Logitech polishing parameters were as follows: head speed=70 rpm, platen speed=67 rpm, total flow rate=100 mL/min.

Condition B: Wafers (300 mm) containing TEOS and plasma enhanced (PE) SiN were cut into coupons and polished using a Logitech 2 benchtop polishing machine at 2 PSI (13.8 kPa) downforce using a Fujibo H700 pad conditioned with a product commercially identified as A82 (3M, St. Paul, MN). Logitech polishing parameters were as follows: head speed=93 rpm, platen speed=87 rpm, total flow rate=150 mL/min.

Condition C: Wafers (300 mm) containing TEOS and plasma enhanced (PE) SiN were cut into coupons and polished using a Logitech 2 benchtop polishing machine at 4 PSI (27.6 kPa) downforce using a Fujibo H700 pad conditioned with a product commercially identified as A82 (3M, St. Paul, MN). Logitech polishing parameters were as follows: head speed=115 rpm, platen speed=112 rpm, total flow rate=66 mL/min.

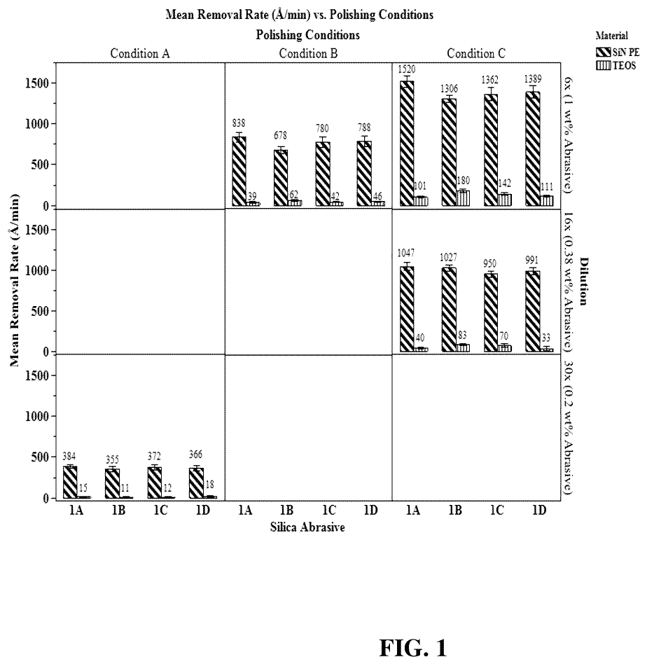

Removal rates were calculated by measuring the film thickness, using spectroscopic ellipsometry, and subtracting the final thickness from the initial thickness, and the results are set forth in FIG. 1.

As is apparent from the results set forth in FIG. 1, the removal rate of plasma enhanced (PE) SiN was more than 10 times greater than the removal rate of TEOS under almost every condition tested. In addition, FIG. 1 shows that surface modified silicate-based silica abrasives 1C and 1D exhibited similar silicon nitride removal rates to aluminum-doped silicate abrasive 1A despite surface modified silicate-based silica abrasives 1C and 1D not containing metal doping (e.g., aluminum doping).

### Example 2

This example shows the plasma enhanced (PE) chemical vapor deposited silicon nitride (SiN) and tetraethyl orthosilicate-derived silicon oxide removal rate (in Å/min) exhibited by silica abrasive compositions, as a function of silica abrasive zeta potential and particle size.

Silica Abrasives 2A (silicate abrasive having a zeta potential of approximately-28 mV and a particle size of 69 nm), 2B (silica abrasive having a zeta potential of approximately −24 mV and a particle size of 34 nm), 2C (silica abrasive having a zeta potential of approximately-23 mV and a particle size of 41 nm), 2D (silica abrasive having a zeta potential of approximately-21 mV and a particle size of 41 nm), and 2E (silica abrasive having a zeta potential of approximately-19 mV and a particle size of 39 nm) were formulated in polishing compositions comprising 6 wt. % silica abrasive and 0.3 wt. % acetic acid, at a pH of 3.3. The zeta potential of the silica abrasive was measured using a Malvern Instrument (Malvern, UK). The resulting polishing compositions were diluted 6× with deionized water prior to polishing.

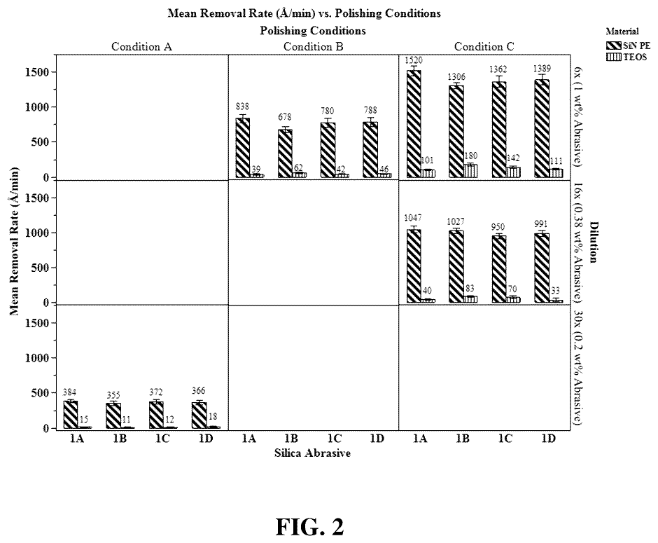

Wafers (300 mm) containing TEOS and plasma enhanced (PE) SiN were cut into coupons and polished using a Logitech 2 benchtop polishing machine at 2 PSI (13.8 kPa) downforce using a Fujibo H700 pad conditioned with a product commercially identified as A82 (3M, St. Paul, MN). Logitech polishing parameters were as follows: head speed=93 rpm, platen speed=87 rpm, total flow rate=150 mL/min. Removal rates were calculated by measuring the film thickness, using spectroscopic ellipsometry, and subtracting the final thickness from the initial thickness, and the results are set forth in FIG. 2.

As is apparent from the results set forth in FIG. 2, the removal rate of plasma enhanced (PE) SiN was more than 10 times greater than the removal rate of TEOS using silica abrasive having zeta potentials ranging from −28 mV to −19 mV and particle sizes ranging from 34 nm to 69 nm. In addition, FIG. 2 shows that the removal rate of plasma enhanced (PE) SiN generally increased as the zeta potential became less negative.

### Example 3

This example shows the plasma enhanced (PE) chemical vapor deposited silicon nitride (SiN), low pressure (LP) chemical vapor deposited silicon nitride (SiN), and tetraethyl orthosilicate-derived silicon oxide removal rates (in Å/min) exhibited by surface modified silicate-based silica abrasive, as a function of silica abrasive zeta potential.

Silica Abrasives 3A (surface modified silicate-based silica abrasive having a zeta potential of approximately-21 mV), 3B (surface modified silicate-based silica abrasive having a zeta potential of approximately-19 mV), and 3C (surface modified silicate-based silica abrasive having a zeta potential of approximately-16 mV) were formulated in polishing compositions comprising 6 wt. % silica abrasive and 0.3 wt. % acetic acid, at a pH of 3.3. The zeta potential of the silica abrasive was measured using a Malvern Instrument (Malvern, UK). The resulting polishing compositions were diluted 6× with deionized water prior to polishing.

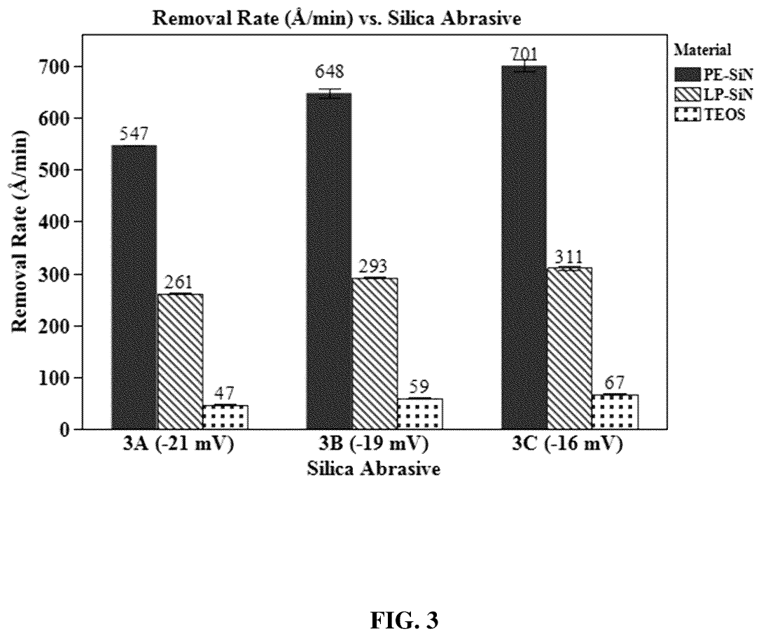

Wafers (300 mm) containing TEOS, plasma enhanced (PE) SiN, and low pressure (LP) SiN were cut into coupons and polished using a Logitech 2 benchtop polishing machine at 2 PSI (13.8 kPa) downforce using a Fujibo H700 pad conditioned with a product commercially identified as A82 (3M, St. Paul, MN). Logitech polishing parameters were as follows: head speed=93 rpm, platen speed=87 rpm, total flow rate=150 mL/min. Removal rates were calculated by measuring the film thickness, using spectroscopic ellipsometry, and subtracting the final thickness from the initial thickness, and the mean removal rate (in Å/min) results are set forth in FIG. 3. The individual data points for each measurement, which were used in calculating the mean removal rate (in Å/min), are also shown in FIG. 3

As is apparent from the results set forth in FIG. 3, the removal rate of plasma enhanced (PE) SiN was more than 10 times greater than the removal rate of TEOS using surface modified silicate-based silica abrasive having zeta potentials ranging from −21 mV to −16 mV. In addition, FIG. 3 shows that the removal rate of plasma enhanced (PE) SiN increased as the zeta potential became less negative.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A chemical-mechanical polishing composition comprising:
(a) about 0.001 wt. % to about 10 wt. % of a silica abrasive;
(b) about 0.05 wt. % to about 2 wt. % of a buffering agent; and
(c) water,
wherein the polishing composition has a pH of about 1 to about 7 and the silica abrasive has a zeta potential of about −10 mV to about −50 mV in the polishing composition, and wherein the silica abrasive is not doped with a metal.

2. The polishing composition of claim 1, wherein the polishing composition comprises about 0.5 wt. % to about 10 wt. % of the silica abrasive.

3. The polishing composition of claim 1, wherein the polishing composition has a pH of about 2 to about 4.

4. The polishing composition of claim 1, wherein the buffering agent comprises a carboxylic acid, a phosphonic acid, or a combination thereof.

5. The polishing composition of claim 4, wherein the buffering agent comprises acetic acid.

6. The polishing composition of claim 4, wherein the buffering agent comprises 1-hydroxyethylidene-1,1-diphosphonic acid.

7. The polishing composition of claim 1, wherein the buffering agent comprises an amino acid.

8. The polishing composition of claim 1, wherein the buffering agent comprises an inorganic acid.

9. The polishing composition of claim 8, wherein the inorganic acid is a phosphoric acid.

10. The polishing composition of claim 1, wherein the silica abrasive has a zeta potential of about −15 mV to about −35 mV in the polishing composition.

11. The polishing composition of claim 1, wherein the silica abrasive has an average particle size of about 30 nm to about 50 nm.

12. A method of chemically-mechanically polishing a substrate comprising:
providing a substrate, wherein the substrate comprises silicon nitride on a surface of the substrate;
providing a polishing pad;
providing a chemical-mechanical polishing composition comprising:
(a) about 0.001 wt. % to about 10 wt. % of a silica abrasive;
(b) about 0.05 wt. % to about 2 wt. % of a buffering agent; and
(c) water,
wherein the polishing composition has a pH of about 1 to about 7 and the silica abrasive has a zeta potential of about −10 mV to about −50 mV in the polishing composition, and wherein the silica abrasive is not doped with a metal;
contacting the substrate with the polishing pad and the chemical-mechanical polishing composition; and
moving the polishing pad and the chemical-mechanical polishing composition relative to the substrate to abrade at least a portion of the substrate to polish the substrate.

13. The method of claim 12, wherein the polishing composition has a pH of about 2 to about 4.

14. The method of claim 12, wherein the buffering agent comprises a carboxylic acid, a phosphonic acid, or a combination thereof.

15. The method of claim 14, wherein the organic acid comprises acetic acid.

16. The method of claim 14, wherein the organic acid comprises 1-hydroxyethylidene-1,1-diphosphonic acid.

17. The method of claim 14, wherein the organic acid comprises an amino acid.

18. The method of claim 13, wherein the silica abrasive has a zeta potential of about −15 mV to about −35 mV in the polishing composition.

19. The method of claim 13, wherein the substrate further comprises silicon oxide on a surface of the substrate, and wherein no silicon oxide on a surface of the substrate is abraded.

20. The method of claim 13, wherein the silica abrasive has an average particle size of about 30 nm to about 50 nm.
